(19) United States
(12) Patent Application Publication
(10) Pub. No.: US 2024/0291088 A1
(43) Pub. Date: Aug. 29, 2024

(54) COMPRESSION SYSTEMS FOR ELECTROCHEMICAL CELLS AND ELECTROCHEMICAL CELL STACKS

(71) Applicant: 24M Technologies, Inc., Cambridge, MA (US)

(72) Inventor: Khosrow NEMATOLLAHI, Carmel, IN (US)

(21) Appl. No.: 18/584,292

(22) Filed: Feb. 22, 2024

Related U.S. Application Data
(60) Provisional application No. 63/448,534, filed on Feb. 27, 2023.

(51) Int. Cl. H01M 50/242; H01M 50/209; H01M 50/291

(52) U.S. Cl. CPC H01M 50/242; H01M 50/209; H01M 50/291

(57) ABSTRACT

Embodiments described herein relate to an electrochemical cell assembly. The electrochemical cell assembly includes a plurality of electrochemical cells arranged in a stack ad a compression assembly. The compression assembly includes a first planar sheet in contact with a first side of the stack, at least one structural member disposed on a first side of the first planar sheet, and a second planar sheet disposed on the at least one structural member, the second planar sheet configured to exert a compressive force on the at least one structural members such that the at least one structural member causes the first planar sheet to exert a substantially uniform distributed pressure on the stack.

### CROSS-REFERENCE TO RELATED APPLICATIONS

The present application claims priority to and benefit of U.S. Provisional Application No. 63/448,534, filed Feb. 27, 2023, and entitled “Compression Systems for Electrochemical Cells and Electrochemical Cell Stacks,” the entire disclosure of which is incorporated herein by reference.

### TECHNICAL FIELD

Embodiments described herein relate to systems and methods for pressurizing electrochemical cells.

### BACKGROUND

Electrochemical cells can swell (e.g., increase in size) during charging. Swelling can decrease an electrochemical cell's volumetric energy density and can affect the function of the electrochemical cell or the function of an electrochemical cell system that the electrochemical cell system is a part of. To decrease the swelling, electrochemical cells can be restrained by using a clamp, pressure plate, or the like to provide a resistive force to the swelling. Current restraining methods, however, do not distribute uniform pressure on an electrochemical cell during use. This may result in warped or damaged electrochemical cells which can affect performance of the electrochemical cells. Thus, a system for uniformly decreasing swelling of an electrochemical cell is desired.

### SUMMARY

In some aspects, embodiments described herein relate to an electrochemical cell assembly. The electrochemical cell assembly includes a plurality of electrochemical cells arranged in a stack and a compression assembly. The compression assembly includes a first planar sheet in contact with a first side of the stack, at least one structural member disposed on a first side of the first planar sheet, and a second planar sheet disposed on the at least one structural member, the second planar sheet configured to exert a compressive force on the at least one structural members such that the at least one structural member causes the first planar sheet to exert a substantially uniform distributed pressure on the stack.

In some embodiments, an assembly includes: a first planar layer configured to be disposed on a surface of an electrochemical cell stack such that a first surface of the first planar layer contacts the surface of the electrochemical cell stack; a structural member is disposed on a second surface of the first planar layer opposite the first surface of the first planar layer; and a second planar layer is disposed on the structural member opposite the second surface of the first planar layer, the second planar layer configured to exert a compressive force on the structural member in response to a force being exerted on the second planar layer such that the structural member causes the first planar layer to exert a substantially uniform distributed pressure on the electrochemical cell stack when the assembly is disposed on the electrochemical cell stack.

In some embodiments, an electrochemical cell assembly includes: a plurality of electrochemical cells arranged in a stack; and a compression assembly including: a planar sheet in contact with a first side of the stack; and at least one structural member disposed on a first side of the first planar sheet. In response to a compressive force being exerted on the at least one structural member in a direction towards the planar sheet, the at least one structural member causes the planar sheet to exert a substantially uniform distributed pressure on the stack.

### BRIEF DESCRIPTION OF THE DRAWINGS

FIG. 1 is a block diagram of an electrochemical cell assembly, according to an embodiment.

FIG. 2 is an illustration of an electrochemical cell assembly, according to an embodiment.

FIG. 3 is an illustration of an electrochemical cell assembly with a first compression assembly separated, according to an embodiment.

FIG. 4 is a top view of an electrochemical cell assembly with ribs exposed, according to an embodiment.

FIG. 5 is a side view of a rib, according to an embodiment.

FIG. 6 is another side view of a rib, according to an embodiment.

FIGS. 7A-7F are simulation results of an electrochemical cell assembly in use, according to an embodiment.

FIG. 8 is an illustration of another electrochemical cell assembly, according to an embodiment.

FIG. 9 is an illustration of the electrochemical cell assembly of FIG. 8 with a honeycomb structure exposed.

FIG. 10 is a top view of a honeycomb structure, according to an embodiment.

FIGS. 11A-111D are simulation results of an electrochemical cell assembly with a honeycomb structure.

### DETAILED DESCRIPTION

Embodiments described herein relate to electrochemical cell assemblies. During operation, such as during charging processes, electrochemical cell stacks can expand. The embodiments described herein include structural members to compress electrochemical cell stacks. The structural members can reduce the likelihood and/or the severity of the electrochemical cell stack expanding during operation. The structural members contact planar sheets to distribute force along a surface of the electrochemical cell stack. A distributed force along the electrochemical cell stack can ensure that electrochemical cell assemblies function as intended. For example, inhibiting, reducing, or eliminating cell stack expansion can reduce a decrease in energy density. Reducing cell stack expansion can also keep heat dissipation at an intended level by reducing the likelihood of the electrochemical cell stack expanding out of thermal contact with a heat sink or the like.

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

Similarly, the term “substantially” when used in connection with “uniform pressure,” “uniform distributed pressure,” “thickness” or other quantitative or qualitative properties of a structure implies that the variation of such quantitative or qualitative properties across the structure, or portions of the structure is within plus or minus 5%.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

As used herein, the term “electrochemical cell” refers to a device that converts chemical energy to electrical energy. Electrochemical cells can be housed within pouches that may allow for heat to dissipate during operation. Connecting electrochemical cells in parallel, series, or any combination thereof forms a battery.

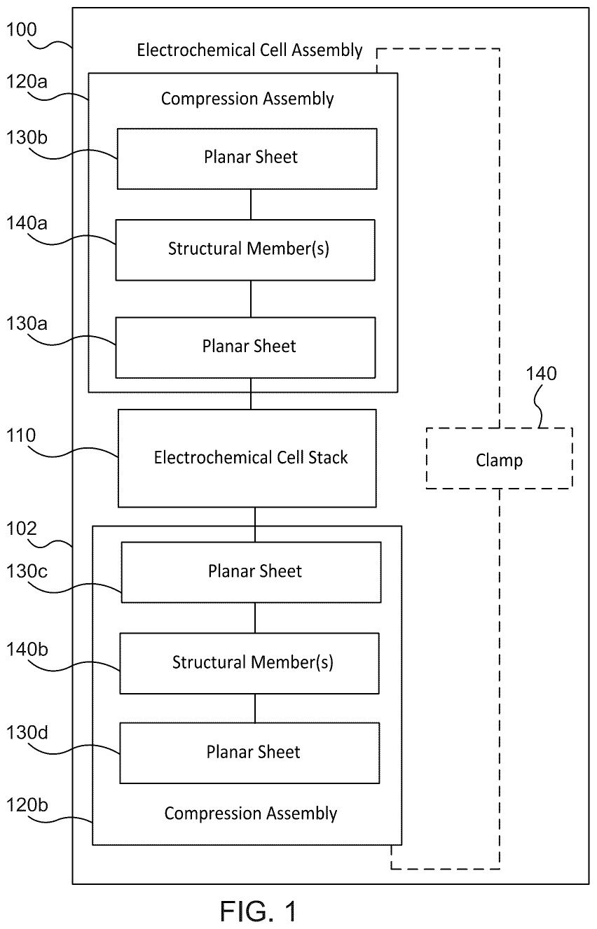

FIG. 1 is a block diagram of an electrochemical cell assembly 100, according to an embodiment. As shown, the electrochemical cell assembly 100 includes an electrochemical cell stack 110, a first compression assembly 120a including a planar sheet or layer 130a, a planar sheet or layer 130b, and structural member(s), and a second compression assembly 120b including a planar sheet or layer 130c, a planar sheet or layer 130d, and structural member(s) 140b. The planar sheet 130a, the planar sheet 130b, the planar sheet 130c, and the planar sheet 130d are collectively known as the planar sheets 130. The structural member(s) 140a and the structural member(s) 140b are collectively known as the structural member(s) 140b.

In some embodiments, the electrochemical cell assembly 100 may include a housing 102 within which the stack 110, the first and the second compression assembly 120a, 120b, and optionally, the clamp 140 may be disposed. While shown in FIG. 1 as including the first and second compression assembly 120a, 120b, in some embodiments, the assembly 100 may include only the first compression assembly 120a or the second compression assembly 120b. Moreover, instead of including the planar sheet 130b, 130d, corresponding sidewalls of the housing 102 may be configured to exert pressure on the structural members 120a, 120b, as described in further detail herein.

In some embodiments, the electrochemical cell assembly 100 includes additional compression assemblies stacked together, each compression assembly including at least a structural member and a planar sheet. In some embodiments, the electrochemical cell assembly 100 includes a clamp 140 configured to impart a compressive force on the first compression assembly 120a and the second compression assembly 120b. In some embodiments, the clamp 140 imparts the compressive force along at least two parallel edges or portions of the top and bottom faces of the electrochemical cell assembly 100. The clamp 140 may include a mechanical clamp, a hydraulic clamp, a pneumatic clamp, or any other suitable clamp, or compression mechanism that can exert a compressive force on the first compression assembly 120a and/or the second compression assembly 120b.

Each of the electrochemical cells can include an anode material disposed on an anode current collector, a cathode material disposed on a cathode current collector, and a separator disposed between the anode material and the cathode material. In some embodiments, the separator can be large enough that a portion of the separator extends beyond an outer edge of the anode material and an outer edge of the cathode material. The electrochemical cells can further include a pouch material at least partially encasing the anode material, the anode current collector, the cathode material, the cathode current collector, and the separator. In some embodiments, the pouch material can contact the anode current collector, the cathode current collector, and/or the separator. The pouch material can be large enough that a portion of the pouch material extends beyond an outer bound of the separator.

The electrochemical cell stack 110 includes multiple electrochemical cells arranged in a stack. In some embodiments, the electrochemical cell stack 110 can include at least about 1, at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 150, at least about 200, at least about 250, at least about 300, at least about 350, at least about 400, at least about 450 electrochemical cells. In some embodiments, the electrochemical cell stack 110 can include no more than about 500, no more than about 450, no more than about 400, no more than about 350, no more than about 300, no more than about 250, no more than about 200, no more than about 150, no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, no more than about 3, or no more than about 2 electrochemical cells. Combinations of the above-referenced numbers of electrochemical cells are also possible (e.g., at least about 1 electrochemical cell and no more than about 500 electrochemical cells or at least about 5 electrochemical cells and no more than about 50 electrochemical cells), inclusive of all values and ranges therebetween. In some embodiments, the electrochemical cell stack 110 can include about 1, about 2, about 3, about 4, about 5, about 6, about 7, about 8, about 9, about 10, about 20, about 30, about 40, about 50, about 60, about 70, about 80, about 90, about 100, about 150, about 200, about 250, about 300, about 350, about 400, about 450, or about 500 electrochemical cells. In some embodiments, the electrochemical cell stack 110 can be sectioned into subgroups of electrochemical cells with thermal spacers between each subgroup.

In some embodiments, the thickness of each of the cells in the electrochemical cell stack 110 is at least about 10 mm, at least about 11 mm, at least about 12 mm, at least about 13 mm, at least about 14 mm, at least about 15 mm, at least about 16 mm, at least about 17 mm, at least about 18 mm, at least about 19 mm, at least about 20 mm, at least about 25 mm, at least about 30 mm, at least about 35 mm, at least about 40 mm, at least about 50 mm, at least about 60 mm, at least about 70 mm, at least about 80 mm, at least about 90 mm, or at least about 100 mm. In some embodiments, the thickness of each of the cells in the electrochemical cell stack 110 is no more than 100 mm, no more than 90 mm, no more than 80 mm, no more than 70 mm, no more than 60 mm, no more than 50 mm, no more than 40 mm, no more than 35 mm, no more than 30 mm, no more than 25 mm, no more than 20 mm, no more than 19 mm, no more than 18 mm, no more than 17 mm, no more than 16 mm, no more than 15 mm, no more than 14 mm, no more than 13 mm, no more than 12 mm, no more than 11 mm, or no more than 10 mm. Combinations of the above-referenced thicknesses are also possible (e.g., at least about 10 mm and no more than 100 mm or at least about 25 mm and no more than 70 mm), inclusive off all ranges and values therebetween. In some embodiments, the thickness of each of the cells in the electrochemical cell stack 110 is about 10 mm, about 11 mm, about 12 mm, about 13 mm, about 14 mm, about 15 mm, about 16 mm, about 17 mm, about 18 mm, about 19 mm, about 20 mm, about 25 mm, about 30 mm, about 35 mm, about 40 mm, about 50 mm, about 60 mm, about 70 mm, about 80 mm, about 90 mm, or about 100 mm. In some embodiments, the electrochemical cell stack 110 includes cells of various thicknesses.

The planar sheets 130 aid in evenly distributing force on the outside surfaces of the electrochemical cell stack 110. In some embodiments, the planar sheets 130 can have the same or substantially similar length and width dimensions to the electrochemical cell stack 110. In some embodiments, the planar sheets 130 can have a slightly larger length and a slightly larger width than the electrochemical cells in the electrochemical cell stack 110, such that the planar sheets 130 can wrap around the electrochemical cell stack 110. In some embodiments, the planar sheets 130 can be composed of a metal (e.g., aluminum, stainless steel, high-strength low-allow steel). In some embodiments, the planar sheets 130 can be composed of a polymer (e.g., polyethylene, polypropylene). In some embodiments, the planar sheets 130 can be composed of a ceramic, alumina, carbide, a composite, a glass-filled plastic, a carbon fiber, or any combination thereof. In some embodiments, the electrochemical cell assembly 100 can include a compliant material (not shown) on a surface of the electrochemical cell stack 110 as a means of evenly distributing pressure. In some embodiments, the compliant material can include a foam, a rubber, or any combination thereof.

In some embodiments, the thickness of the planar sheets 130 is at least about 1 mm, at least about 1.1 mm, at least about 1.2 mm, at least about 1.3 mm, at least about 1.4 mm, at least about 1.5 mm, at least about 1.6 mm, at least about 1.7 mm, at least about 1.8 mm, at least about 1.9 mm, at least about 2 mm, at least about 3 mm, at least about 4 mm, at least about 5 mm, at least about 6 mm, at least about 7 mm, at least about 8 mm, at least about 9 mm, or at least about 10 mm. In some embodiments, the thickness of the planar sheets 130 is no more than 10 mm, no more than 9 mm, no more than 8 mm, no more than 7 mm, no more than 6 mm, no more than 5 mm, no more than 4 mm, no more than 3 mm, no more than 2 mm, no more than 1.9 mm, no more than 1.8 mm, no more than 1.7 mm, no more than 1.6 mm, no more than 1.5 mm, no more than 1.4 mm, no more than 1.3 mm, no more than 1.2 mm, no more than 1.1 mm, or no more than 1 mm. Combinations of the above-referenced thicknesses are also possible (e.g., at least about 1 mm and no more than 10 mm or at least about 3 mm and no more than 7 mm), inclusive of all ranges and values therebetween. In some embodiments, the thickness of the planar sheets 130 is about 1 mm, about 1.1 mm, about 1.2 mm, about 1.3 mm, about 1.4 mm, about 1.5 mm, about 1.6 mm, about 1.7 mm, about 1.8 mm, about 1.9 mm, about 2 mm, about 3 mm, about 4 mm, about 5 mm, about 6 mm, about 7 mm, about 8 mm, about 9 mm, or about 10 mm.

The structural members 140 press against the planar sheets 130. The structural members 140 are configured to distribute force from the outside planar sheets (130b and 130d) to the inner planar sheets (130a and 130c) such that the pressure distribution is substantially even across the surface of the inner planar sheets (130a and 130c). In some embodiments, the structural members 140 include a set of structural members disposed at predetermined locations on the planar sheets 130. In some embodiments, the structural members 130 include ribs. In some embodiments, the ribs each includes a curved face and a flat face. In some embodiments, the structural members 140 include a porous mesh, for example, a sheet defining a plurality of cells. In some embodiments, each cell of the plurality of cells has a hexagonal shape such that the mesh has a honeycomb structure. A mesh like structural member 140 may provide the benefit of being light weight reducing the overall weight contribution by the compression assemblies 120a, 120b to the assembly 100, as well as providing space for air flow and radiative heat transfer through the plurality of cells.

In some embodiments, the structural member(s) 140a are the same as the structural member 140b. For example, the structural member(s) 140a and the structural member(s) can both be ribs. In some embodiments, the structural member(s) 140a are different than the structural member(s) 140b. For example, the structural member(s) 140a may be ribs while the structural member(s) 140b may be a mesh. The structural members 140 are formed of a stiff material to distribute the force as intended. For example, the structural members 140 can be formed of a metal (e.g., aluminum, etc.), plastic polymer (e.g., polyethylene, polyurethane, etc.), and/or a composite (e.g., fiberglass, etc.). In some embodiments, a structural member 140 with a higher moment of inertia may be desired as to lower the stress on the electrochemical cell stack 110.

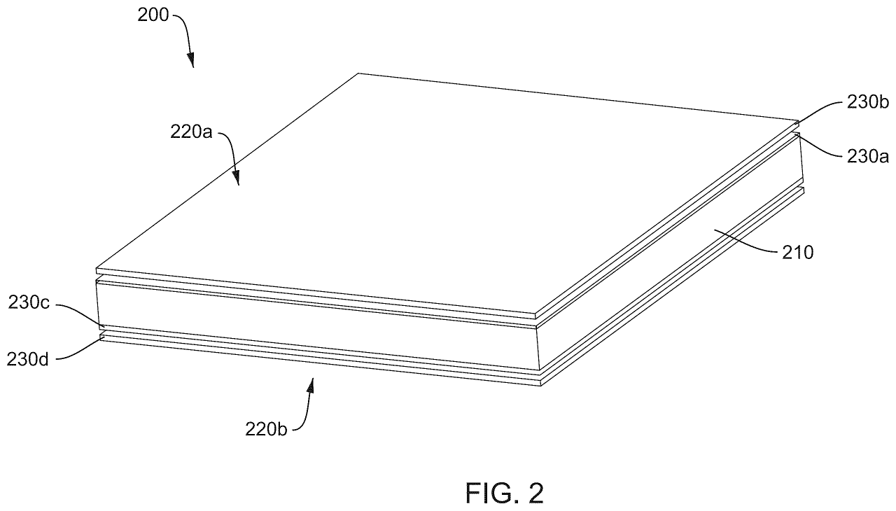

FIG. 2 is an illustration of an electrochemical cell assembly 200 (e.g., functionally and/or structurally similar to the electrochemical cell assembly 100 of FIG. 1), according to an embodiment. The electrochemical cell assembly includes an electrochemical cell stack 210 (e.g., functionally and/or structurally similar to the electrochemical cell stack 110 of FIG. 1), a first compression assembly 220a (e.g., functionally and/or structurally similar to the first compression assembly 120a of FIG. 1) and a second compression assembly 220b (e.g., functionally and/or structurally similar to the second compression assembly 120b of FIG. 1).

The first compression assembly 220a includes a planar sheet 230a (e.g., functionally and/or structurally similar to the planar sheet 130a of FIG. 1) and a planar sheet 230b (e.g., functionally and/or structurally similar to the planar sheet 130b of FIG. 1). Located between the planar sheet 230a and the planar sheet 230b is a structural member(s) (e.g., functionally and/or structurally similar to the structural member 140a of FIG. 1). The planar sheet 230a contacts a first surface of the electrochemical cell stack 210. In some embodiments, the planar sheet 230a is the same size as the first surface of the electrochemical cell stack 210. In some embodiments, the planar sheet 230a is larger than the first surface of the electrochemical cell stack 210. During operation of the electrochemical cell assembly 200, a pressing force is imparted on the planar sheet 230b towards the electrochemical cell stack 210. The force may be a point force on a surface of the planar sheet 230b or can be a distributed force, such as a force along at least one edge or top face of the planar sheet 230b. The planar sheet 230b transfers the force to the structural member(s), which distribute the force onto the planar sheet 230a, which transfers the distributed force onto the first surface of the electrochemical cell stack 210. The distributed force provides an even pressure distribution across the first surface of the electrochemical cell stack 210. In some embodiments, the planar sheet 230b and the structural member are configured to reduce the assembly weight of the electrochemical cell assembly 200. In some embodiments, the planar sheets 230b undergoes elastic deformation such that the planar sheet 230b returns to an original undeformed shape after the applied forces are released.

The second compression assembly 220b includes a planar sheet 230c (e.g., functionally and/or structurally similar to the planar sheet 130c of FIG. 1) and a planar sheet 230 (e.g., functionally and/or structurally similar to the planar sheet 130d of FIG. 1). Located between the planar sheet 230a and the planar sheet 230b is a structural member(s) (e.g., functionally and/or structurally similar to the structural member 140a of FIG. 1). The planar sheet 230c contacts a second surface, opposite of the first surface of the electrochemical cell stack 210. In some embodiments, the planar sheet 230c is the same size as the second surface of the electrochemical cell stack 210. In some embodiments, the planar sheet 230c is larger than the second surface of the electrochemical cell stack 210. During operation of the electrochemical cell assembly, a pressing force is imparted on the planar sheet 230d towards the electrochemical cell stack 210. The force may be a point force on a surface of the planar sheet 230d or can be a distributed force, such as a force along at least one edge or/and one face of the planar sheet 230d. The planar sheet 230d transfers the force to the structural member(s), which distribute the force onto the planar sheet 230c, which transfers the distributed force onto the second surface of the electrochemical cell stack 210. The distributed force provides an even pressure distribution across the second surface of the electrochemical cell stack 210. The distributed forces on the first surface and the second surface compress the electrochemical cell stack 210 such that during operation, the compression reduces or eliminates swelling of the electrochemical cell stack 210.

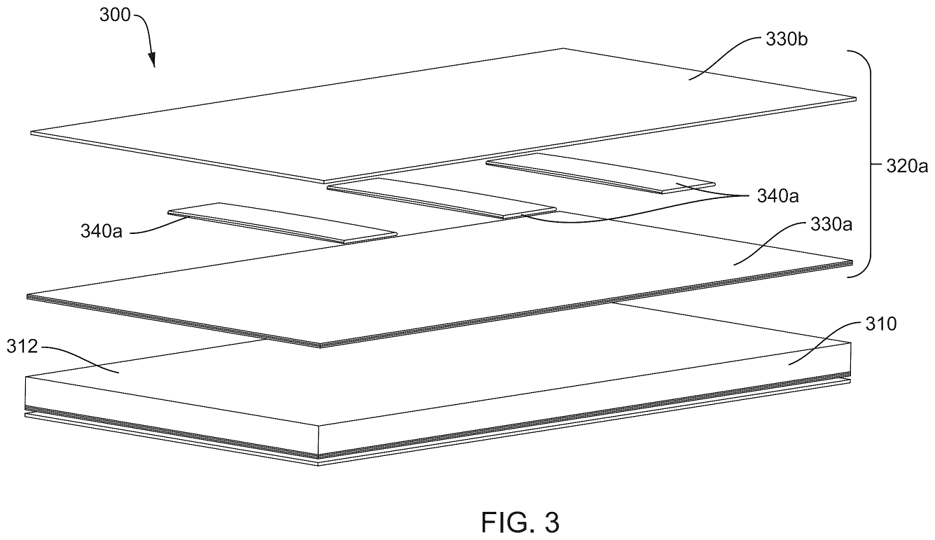

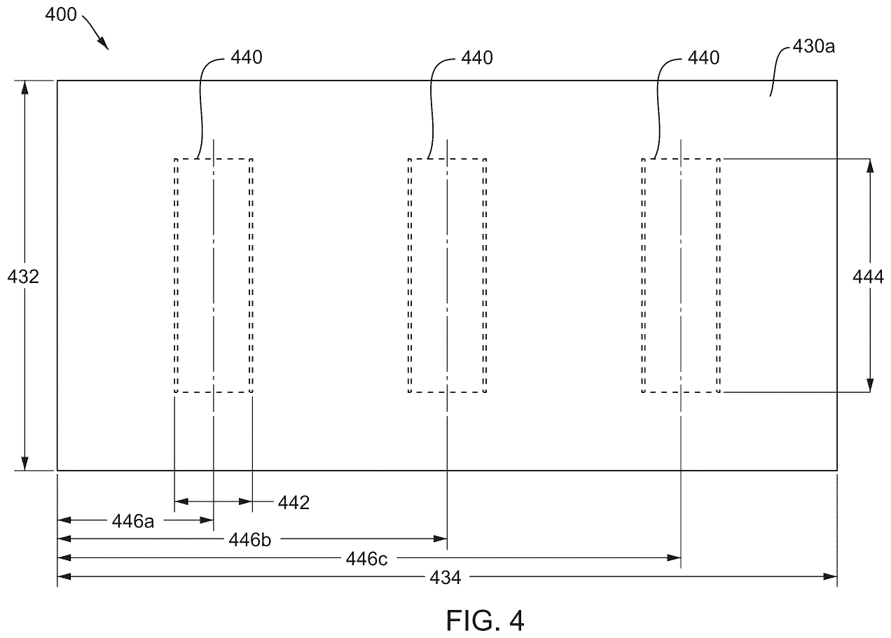

FIG. 3 is an illustration of an electrochemical cell assembly 300 (e.g., structurally and/or functionally similar to the electrochemical cell assembly 100 of FIG. 1 and/or the electrochemical cell assembly 200 of FIG. 2) with a first compression assembly 320a (e.g., functionally and/or structurally similar to the first compression assembly 120a of FIG. 1 and/or the first compression assembly 220a of FIG. 2) separated, according to an embodiment. The electrochemical cell assembly 300 includes an electrochemical cell stack 310 (e.g., functionally and/or structurally similar to the electrochemical cell stack 110 of FIG. 1 and/or the electrochemical cell stack 210 of FIG. 2) stacked between the first compression assembly 320a and a second compression assembly 320b (e.g., structurally and/or functionally similar to the second compression assembly 120b of FIG. 1 and/or second compression assembly 220b of FIG. 2).

FIG. 3 illustrates the components of the first compression assembly 320a separated. In operation, the components would be compressed together against the electrochemical cell stack 310. The components of the first compression assembly 320a includes as a planar sheet 330a (e.g., structurally and/or functionally similar to the planar sheet 130a of FIG. 1 and/or the planar sheet 230a of FIG. 2), ribs 340a (e.g., structurally and/or functionally similar to the structural member(s) 140 of FIG. 1), and a planar sheet 330b (e.g., structurally and/or functionally similar to the planar sheet 130b of FIG. 1 and/or the planar sheet 230b of FIG. 2). The planar sheet 330a is located, in the electrochemical cell assembly 300, adjacent to a first surface 312 of the electrochemical cell stack 310.

Stacked on top of the planar sheet 330a are three ribs 340a. In some embodiments, the electrochemical cell assembly 300 includes at least one rib, at least two ribs, at least three ribs, at least four ribs, at least five ribs, at least six ribs, at least seven ribs, at least eight ribs, at least nine ribs, at least 10 ribs, at least 15 ribs, at least 20 ribs, at least 25 ribs, or at least 30 ribs. In some embodiments, the electrochemical cell assembly 300 includes no more than 30 ribs, no more than 25 ribs, no more than 20 ribs, no more than 15 ribs, no more than 10 ribs, no more than nine ribs, no more than eight ribs, no more than seven ribs, no more than six ribs, no more than five ribs, no more than four ribs, no more than three ribs, no more than two ribs, or no more than one rib. Combinations of the above-referenced number of ribs are also possible (e.g., at least about one rib and no more than 30 ribs or at least about six ribs and no more than 15 ribs), inclusive of all ranges and values therebetween. In some embodiments, the electrochemical cell assembly 300 includes one rib, two ribs, three ribs, four ribs, five ribs, six ribs, seven ribs, eight ribs, nine ribs, 10 ribs, 15 ribs, 20 ribs, 25 ribs, or 30 ribs. In some embodiments, the number of ribs is determined to minimize the weight of the electrochemical cell assembly 300 while providing desired structural support.

The size and location of the ribs 340a is configured to distribute force from the planar sheet 330b onto the planar sheet 330a such that the resulting pressure from the planar sheet 330a on the first surface 312 is substantially uniform across the first surface 312. For example, if the force on the planar sheet 330b is along at least two opposite edges of the planar sheet 330b, the ribs 340a can be configured to distribute the force more centrally on to the planar sheet 330a. The ribs 340a allow for a uniform pressure on the electrochemical cell stack 310 without adding as much weight as a compressive plate, that covers the entire first surface 312, would. The second compression assembly 320b can also include a similar configuration to that of the first compression assembly 320a.

FIG. 4 is a top view of an electrochemical cell assembly 400 (e.g., functionally and/or structurally similar to any of the electrochemical cell assemblies described herein such as the electrochemical cell assembly 100 of FIG. 1) with ribs 440 (e.g., structurally and/or functionally similar to the structural member(s) 140 of FIG. 1 and/or the ribs 340a of FIG. 3) exposed, according to an embodiment. The ribs 440 are disposed on a planar sheet 430a (e.g., structurally and/or functionally similar to any one of the planar sheets described herein such as the planar sheet 130a of FIG. 1).

The planar sheet 430a defines a width 432 and a length 434. In some embodiments, the width 432 is at least about 10 mm, at least about 15 mm, at least about 20 mm, at least about 25 mm, at least about 30 mm, at least about 40 mm, at least about 50 mm, at least about 75 mm, at least about 100 mm, at least about 150 mm, at least about 200 mm, at least about 250 mm, at least about 300 mm, at least about 400 mm, at least about 500 mm, at least about 600 mm, at least about 700 mm, at least about 800 mm, at least about 900 mm, at least about 1000 mm, at least about 1100 mm, at least about 1200 mm, at least about 1300 mm, at least about 1400 mm, or at least about 1500 mm. In some embodiments, the width 432 is no more than about 1500 mm, no more than about 1400 mm, no more than about 1300 mm, no more than about 1200 mm, no more than about 1100 mm, no more than about 1000 mm, no more than about 900 mm, no more than about 800 mm, no more than about 700 mm, no more than about 600 mm, no more than about 500 mm, no more than about 400 mm, no more than about 300 mm, no more than about 200 mm, no more than about 150 mm, no more than about 100 mm, no more than about 75 mm, no more than about 50 mm, no more than about 40 mm, no more than about 30 mm, no more than about 25 mm, no more than about 20 mm, no more than about 15 mm, or no more than about 10 mm. Combinations of the above-referenced widths (e.g., at least about 10 mm and no more than 1500 mm or at least about 300 mm and no more than 100 mm), inclusive of all ranges and values therebetween. In some embodiments, the width 432 is about 10 mm, about 15 mm, about 20 mm, about 25 mm, about 30 mm, about 40 mm, about 50 mm, about 75 mm, about 100 mm, about 150 mm, about 200 mm, about 250 mm, about 300 mm, about 400 mm, about 500 mm, about 600 mm, about 700 mm, about 800 mm, about 900 mm, about 1000 mm, about 1100 mm, about 1200 mm, about 1300 mm, about 1400 mm, or about 1500 mm.

In some embodiments, the length 434 is at least about 10 mm, at least about 15 mm, at least about 20 mm, at least about 25 mm, at least about 30 mm, at least about 40 mm, at least about 50 mm, at least about 75 mm, at least about 100 mm, at least about 150 mm, at least about 200 mm, at least about 250 mm, at least about 300 mm, at least about 400 mm, at least about 500 mm, at least about 600 mm, at least about 700 mm, at least about 800 mm, at least about 900 mm, at least about 1000 mm, at least about 1100 mm, at least about 1200 mm, at least about 1300 mm, at least about 1400 mm, or at least about 2000 mm. In some embodiments, the length 434 is no more than about 2000 mm, no more than about 1400 mm, no more than about 1300 mm, no more than about 1200 mm, no more than about 1100 mm, no more than about 1000 mm, no more than about 900 mm, no more than about 800 mm, no more than about 700 mm, no more than about 600 mm, no more than about 500 mm, no more than about 400 mm, no more than about 300 mm, no more than about 200 mm, no more than about 150 mm, no more than about 100 mm, no more than about 75 mm, no more than about 50 mm, no more than about 40 mm, no more than about 30 mm, no more than about 25 mm, no more than about 20 mm, no more than about 15 mm, or no more than about 10 mm. Combinations of the above-referenced lengths (e.g., at least about 10 mm and no more than 2000 mm or at least about 300 mm and no more than 100 mm), inclusive of all ranges and values therebetween. In some embodiments, the length 434 is about 10 mm, about 15 mm, about 20 mm, about 25 mm, about 30 mm, about 40 mm, about 50 mm, about 75 mm, about 100 mm, about 150 mm, about 200 mm, about 250 mm, about 300 mm, about 400 mm, about 500 mm, about 600 mm, about 700 mm, about 800 mm, about 900 mm, about 1000 mm, about 1100 mm, about 1200 mm, about 1300 mm, about 1400 mm, or about 2000 mm. In some embodiments, the length 434 is greater than the width 432.

The ribs define a width 442 and a length 444. In some embodiments, the width 442 is at least about 5 mm, at least about 6 mm, at least about 7 mm, at least about 8 mm, at least about 9 mm, at least about 10 mm, at least about 15 mm, at least about 20 mm, at least about 25 mm, at least about 30 mm, at least about 40 mm, at least about 50 mm, at least about 75 mm, at least about 100 mm, at least about 125 mm, at least about 150 mm, at least about 200 mm, at least about 250 mm, at least about 300 mm, at least about 400 mm, or at least about 500 mm. In some embodiments, the width 442 is no more than about 500 mm, no more than about 400 mm, no more than about 300 mm, no more than about 250 mm, no more than about 200 mm, no more than about 150 mm, no more than about 125 mm, no more than about 100 mm, no more than about 75 mm, no more than about 50 mm, no more than about 40 mm, no more than about 30 mm, no more than about 25 mm, no more than about 20 mm, no more than about 15 mm, no more than about 10 mm, no more than about 9 mm, no more than about 8 mm, no more than about 7 mm, no more than about 6 mm, or no more than about 5 mm. Combinations of the above-referenced widths are also possible (e.g., at least about 5 mm and no more than 500 mm or at least about 50 mm and no more than 300 mm), inclusive of all ranges and values therebetween. In some embodiments, the width 442 is about 5 mm, about 6 mm, about 7 mm, about 8 mm, about 9 mm, about 10 mm, about 15 mm, about 20 mm, about 25 mm, about 30 mm, about 40 mm, about 50 mm, about 75 mm, about 100 mm, about 125 mm, about 150 mm, about 175 mm, about 200 mm, about 250 mm, about 300 mm, about 400 mm, or about 500 mm.

In some embodiments, the ratio of the width 442 to the length 434 is at least about 1:2, at least about 1:2.1, at least about 1:2.2, at least about 1:2.3, at least about 1:2.4, at least about 1:2.5, at least about 1:3, at least about 1:3.5, at least about 1:4, at least about 1:5, at least about 1:6, at least about 1:7, at least about 1:8, at least about 1:9, at least about 1:10, at least about 1:11, at least about 1:12, at least about 1:13, at least about 1:14, or at least about 1:15. In some embodiments, the ratio of the width 442 to the length 434 is no more than about 1:15, no more than about 1:14, no more than about 1:13, no more than about 1:12, no more than about 1:11, no more than about 1:10, no more than about 1:9, no more than about 1:8, no more than about 1:7, no more than about 1:6, no more than about 1:5, no more than about 1:4, no more than about 1:3, no more than about 1:2.5, no more than about 1:2.4, no more than about 1:2.3, no more than about 1:2.2, no more than about 1:2.1, or no more than about 1:2. Combinations of the above referenced ratios are also possible (e.g., at least about 1:2 and no more than about 1:15 or at least about 1:5 and no more than about 1:10), inclusive of all ranges and values therebetween. In some embodiments, the ratio of the width 442 to the length 434 is about 1:2, about 1:2.1, about 1:2.2, about 1:2.3, about 1:2.4, about 1:2.5, about 1:3, about 1:4, about 1:5, about 1:6, about 1:7, about 1:8, about 1:9, about 1:10, about 1:11, about 1:12, about 1:13, about 1:14, or about 1:15.

In some embodiments, the length 444 is at least about 10 mm, at least about 11 mm, at least about 12 mm, at least about 13 mm, at least about 14 mm, at least about 15 mm, at least about 20 mm, at least about 25 mm, at least about 30 mm, at least about 40 mm, at least about 50 mm, at least about 75 mm, at least about 100 mm, at least about 150 mm, at least about 200 mm, at least about 250 mm, at least about 300 mm, at least about 400 mm, at least about 500 mm, at least about 600 mm, at least about 700 mm, at least about 800 mm, at least about 900 mm, at least about 1000 mm. In some embodiments, the length 444 is no more than about 1000 mm, no more than about 900 mm, no more than about 800 mm, no more than about 700 mm, no more than about 600 mm, no more than about 600 mm, no more than about 500 mm, no more than about 400 mm, no more than about 300 mm, no more than about 200 mm, no more than about 150 mm, no more than about 100 mm, no more than about 75 mm, no more than about 50 mm, no more than about 40 mm, no more than about 30 mm, no more than about 25 mm, no more than about 20 mm, no more than about 15 mm, no more than about 14 mm, no more than about 13 mm, no more than about 12 mm, no more than about 11 mm, or no more than about 10 mm. Combinations of the above-referenced lengths is also possible (e.g., at least about 10 mm and no more than about 1000 mm or at least about 50 mm and no more than 500 mm), inclusive of all ranges and values therebetween.

In some embodiments, the ratio of the length 444 to the width 432 is at least about 1:1.1, at least about 1:1.2, at least about 1:1.3, at least about 1:1.4, at least about 1:1.5, at least about 1:2, at least about 1:2.5, at least about 1:3, at least about 1:3.5, at least about 1:4, at least about 1:5, or at least about 1:10. In some embodiments, the ratio of the length 444 to the width 432 is no more than about 1:10, no more than about 1:5, no more than about 1:4, no more than about 1:3, no more than about 1:3, no more than about 1:2, no more than about 1:1.5, no more than about 1:1.4, no more than about 1:1.3, no more than about 1:1.2, or no more than about 1:1.1. Combinations of the above-referenced ratios are also possible (e.g., at least about 1:1.1 and no more than about 1:10 or at least about 1:3 and no more than about 1:10), inclusive of all ranges and values therebetween. In some embodiments, the ratio of length 444 to the width 432 is about 1:1.1, about 1:1.2, about 1:1.3, about 1:1.4, about 1:1.5, about 1:2, about 1:2.5, about 1:3, about 1:3.5, about 1:4, about 1:5, or about 1:10.

In some embodiments, the ratio of width 442 to length 444 is at least about 1:1, at least about 1:1.1, at least about 1:1.2, at least about 1:1.3, at least about 1:1.4, at least about 1:1.5, at least about 1:2, at least about 1:2.5, at least about 1:3, at least about 1:4, at least about 1:5, at least about 1:6, at least about 1:7, at least about 1:8, at least about 1:9, at least about 1:10, at least about 1:15, or at least about 1:20. In some embodiments, the ratio of width 442 to length 444 is no more than about 1:20, no more than about 1:15, no more than about 1:10, no more than about 1:9, no more than about 1:8, no more than about 1:7, no more than about 1:6, no more than about 1:5, no more than about 1:4, no more than about 1:3, no more than about 1:2.5, no more than about 1:2, no more than about 1:1.5, no more than about 1:1.4, no more than about 1:1.3, no more than about 1:1.2, no more than about 1:1.1, or no more than about 1:1. Combinations of the above-referenced ratios are also possible (e.g., at least about 1:1 and no more than about 1:20 or at least about 1:5 and no more than about 1:7), inclusive of all ranges and values therebetween. In some embodiments, the ratio of width 442 to length 444 is about 1:1, about 1:1.1, about 1:1.2, about 1:1.3, about 1:1.4, about 1:1.5, about 1:2, about 1:2.5, about 1:3, about 1:4, about 1:5, about 1:6, about 1:7, about 1:8, about 1:9, about 1:10, about 1:15, or about 1:20.

The locations of the ribs 440 on the planar sheet 430 can be related to at least one of the rib size, magnitude of the force imparted on the planar sheet, location(s) of the force imparted on the planar sheet, number of ribs, and the like. The ribs 440 can be disposed at various locations along the length of the planar sheet 430. For example, the vertical center of the three ribs 440 shown in FIG. 4 are located at a first distance 446a, a second distance 446b, and a third distance 446c, respectively, from one edge of the planar sheet 430a. In some embodiments, the ribs 440 are evenly spaced across the length 434 of the planar sheet 430a. For example, the first distance 446a is 25% of the length 434, the second distance 446b 50% of the length 434, and the third distance 446c is 75% of the length 434. In some embodiments, one of the ribs 440 is disposed at a central location or about a geometrical center of the planar sheet 430, for example, about a midpoint along the width 432 and the length 434 of the planar sheet 430. The other two ribs 440 may be disposed one either side of the central 440, for example, equidistant from an edge of the central rib 440, and may be oriented along the same direction as the central rib 440.

In some embodiments, the first distance 446a is at least about 5%, at least about 6%, at least about 7%, at least about 8%, at least about 9%, at least about 10%, at least about 15%, at least about 20%, at least about 25%, at least about 30%, at least about 35%, or at least about 40% of the length 434. In some embodiments, the first distance 446a is no more than about 40%, no more than about 35%, no more than about 30%, no more than about 25%, no more than about 20%, no more than about 15%, no more than about 10%, no more than about 9%, no more than about 8%, no more than about 7%, no more than about 6%, or no more than about 5% of the length 434. Combinations of the above-referenced ratios are also possible (e.g., at least about 5% and no more than 40% or at least about 15% and no more than 30%), inclusive of all ranges and values therebetween. In some embodiments, the first distance 446a is about 5%, about 6%, about 7%, about 8%, about 9%, about 10%, about 15%, about 20%, about 25%, about 30%, about 35%, or about 40% of the length 434.

In some embodiments, the second distance 446b is at least about 25%, at least about 26%, at least about 27%, at least about 28%, at least about 29%, at least about 30%, at least about 35%, at least about 40%, at least about 45%, at least about 50%, at least about 55%, at least about 60%, at least about 65%, at least about 70%, or at least about 75% of the length 434. In some embodiments, the second distance 446b is no more than about 75%, no more than about 70%, no more than about 65%, no more than about 60%, no more than about 55%, no more than about 50%, no more than about 45%, no more than about 40%, no more than about 35%, no more than about 30%, no more than about 29%, no more than about 28%, no more than about 27%, no more than about 26%, or no more than about 25% of the length 434. Combinations of the above-referenced ratios are also possible (e.g., at least about 25% and no more than 75% or at least about 45% and no more than 70%), inclusive of all ranges and values therebetween. In some embodiments, the second distance 446b is about 25%, about 26%, about 27%, about 28%, about 29%, about 30%, about 35%, about 40%, about 45%, about 50%, about 55%, about 60%, about 65%, about 70%, or about 75% of the length 434.

In some embodiments, the third distance 446c is at least about 60%, at least about 61%, at least about 62%, at least about 63%, at least about 64%, at least about 65%, at least about 70%, at least about 75%, at least about 80%, at least about 85%, at least about 90%, or at least about 95% of the length 434. In some embodiments, the third distance 446c is no more than about 95%, no more than about 90%, no more than about 85%, no more than about 80%, no more than about 75%, no more than about 60%, no more than about 65%, no more than about 64%, no more than about 63%, no more than about 62%, no more than about 61%, or no more than about 60% of the length 434. Combinations of the above-referenced ratios are also possible (e.g., at least about 60% and no more than 95% or at least about 75% and no more than 85%), inclusive of all ranges and values therebetween. In some embodiments, the third distance 446c is about 61%, about 62%, about 63%, about 64%, about 65%, about 70%, about 75%, about 80%, about 85%, about 90%, or about 95% of the length 434.

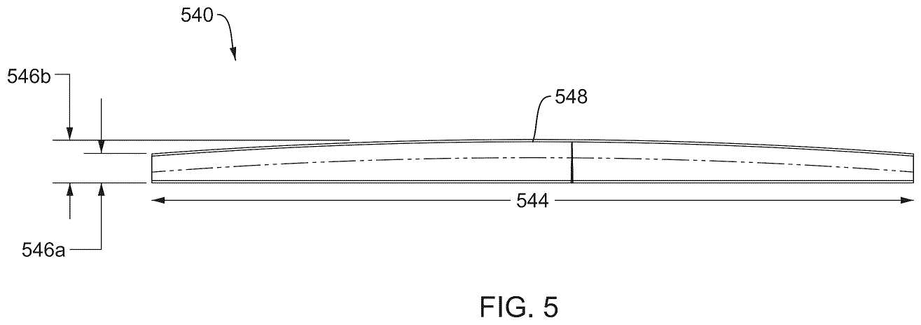

FIG. 5 is a side view of a rib 540 (e.g., functionally and/or structurally similar to the structural member(s) 140 of FIG. 1 and/or the ribs 340a of FIG. 3 and/or the ribs 440 of FIG. 4), according to an embodiment. The rib 540 includes a curved surface that faces a first planar plate or layer that is configured to be disposed on an electrochemical cell stack (e.g., the planar sheet 130a or 130b) and a flat surface that faces away from the first planar sheet. The curved surface is configured to match the deformation of a second planar sheet (e.g., the planar sheet 130b and/or the planar sheet 130d of FIG. 1) that is disposed thereon and urged towards the rib 540 so that the flat surface can transfer and distribute forces down into the planar sheet (e.g., the planar sheet 130a and/or the planar sheet 130c of FIG. 1). In some embodiments, the curve of the rib 540 is configured such that the when the planar sheet is pressed into the rib 540, the planar sheet deforms within its plastic range such that the planar sheet returns to an undeformed position when no longer receiving a force.

The curved surface curves along the length 544 (e.g., structurally and/or functionally similar to the length 444 of FIG. 4) from a first height 546a at the edges of the rib 540 to a second height 546b at an apex 548.

In some embodiments, the first height 546a is at least about 0.1 mm, at least about 0.2 mm, at least about 0.3 mm, at least about 0.4 mm, at least about 0.5 mm, at least about 1 mm, at least about 1.1 mm, at least about 1.2 mm, at least about 1.3 mm, at least about 1.4 mm, at least about 1.4 mm, at least about 1.5 mm, at least about 2 mm, at least about 2.5 mm, at least about 3 mm, at least about 4 mm, at least about 5 mm, at least about 6 mm, at least about 7 mm, at least about 8 mm, at least about 9 mm, or at least about 10 mm. In some embodiments, the first height 546a is no more than about 10 mm, no more than about 9 mm, no more than about 8 mm, no more than about 7 mm, no more than about 6 mm, no more than about 5 mm, no more than about 5 mm, no more than about 4 mm, no more than about 3 mm, no more than about 2.5 mm, no more than about 2 mm, no more than about 1.5 mm, no more than about 1.4 mm, no more than about 1.3 mm, no more than about 1.2 mm, no more than about 1.1 mm, no more than about 1 mm, no more than about 0.5 mm, or no more than about 0.1 mm. Combinations of the above-referenced heights are also possible (e.g., at least about 0.1 mm and no more than about 10 mm or at least about 3 mm and no more than about 5 mm). In some embodiments, the first height 546a is about 1 mm, about 1.1 mm, about 1.2 mm, about 1.3 mm, about 1.4 mm, about 1.5 mm, about 2 mm, about 2.5 mm, about 3 mm, about 4 mm, about 5 mm, about 6 mm, about 7 mm, about 8 mm, about 9 mm, or about 10 mm.

In some embodiments, the second height 546b is at least about 0.5 mm, at least about 0.6 mm, at least about 0.7 mm, at least about 0.8 mm, at least about 0.9 mm, at least 1 mm, at least about 1.5 mm, at least about 2 mm, at least about 3 mm, at least about 4 mm, at least about 5 mm, at least about 6 mm, at least about 7 mm, at least about 8 mm, at least about 9 mm, or at least about 15 mm. In some embodiments, the second height 546b is no more than about 15 mm, no more than about 9 mm, no more than about 8 mm, no more than about 7 mm, no more than about 6 mm, no more than about 5 mm, no more than about 4 mm, no more than about 3 mm, no more than about 2 mm, no more than about 1.5 mm, no more than about 1 mm, no more than about 0.9 mm, no more than about 0.8 mm, no more than about 0.7 mm, no more than about 0.6 mm, or no more than about 0.5 mm. Combinations of the above-referenced heights are also possible (e.g., at least about 0.5 mm and no more than about 10 mm or at least about 3 mm and no more than about 5 mm). In some embodiments, the second height 546b is about 0.5 mm, about 0.6 mm, about 0.7 mm, about 0.8 mm, about 0.9 mm, about 1 mm, about 1.5 mm, about 2 mm, about 3 mm, about 4 mm, about 5 mm, about 6 mm, about 7 mm, about 8 mm, about 9 mm, or about 15 mm.

In some embodiments, the ratio of the second height 546b to the first height 546b is at least about 1:1, at least about 1.1:1, at least about 1.2:1, at least about 1.3:1, at least about 1.4:1, at least about 1.5:1, at least about 2:1, at least about 3:1, at least about 4:1, at or least about 5:1. In some embodiments, the ratio of the second height 546b to the first height 546a is no more than about 5:1, no more than about 4:1, no more than about 3:1, no more than about 2:1, no more than about 1.5:1, no more than about 1.4:1, no more than about 1.3:1, no more than about 1.2:1, or no more than about 1.1:1. Combinations of the above-referenced ratios are also possible (e.g., e.g., at least about 1.1:1 and no more than 5:1 or at least about 1.2:1 and no more than about 3:1), inclusive of all ranges and values therebetween. In some embodiments, the ratio between the second height 546b and the first height 546a is about 1.1:1, about 1.2:1, about 1.3:1, about 1.4:1, about 1.5:1, about 2:1, about 3:1, about 4:1, about 5:1.

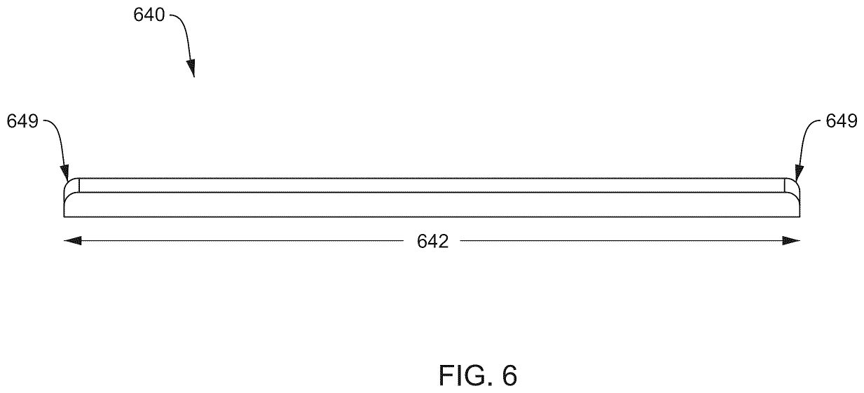

FIG. 6 is another side view of a rib 640 (e.g., structurally and/or functionally similar to the structural member(s) 140 of FIG. 1 or any of the ribs described herein such as the rib 440 of FIG. 4), according to an embodiment. The rib includes a filleted edges 649 along the edges of the width 642 (e.g., structurally and/or functionally similar to the width 442 of FIG. 4). The filleted edges 649 reduces stress concentrations in the corners of the rib 640 when a pressing force is applied to the rib 640. In some embodiments, the radius of curvature of the filleted edges 649 is at least about 1 mm, at least about 1.1 mm, at least about 1.2 mm, at least about 1.3 mm, at least about 1.4 mm, at least about 1.5 mm, at least about 2 mm, at least about 2.5 mm, at least about 3 mm, at least about 4 mm, at least about 5 mm, at least about 10 mm, at least about 15 mm, or at least about 20 mm. In some embodiments, the radius of curvature of the filleted edges 649 is no more than about 20 mm, no more than about 15 mm, no more than about 10 mm, no more than about 5 mm, no more than about 4 mm, no more than about 3 mm, no more than about 2.5 mm, no more than about 2 mm, no more than about 1.5 mm, no more than about 1.4 mm, no more than about 1.3 mm, no more than about 1.2 mm, or no more than about 1.1 mm. Combinations of the above-referenced radii of curvature are also possible (e.g., at least about 1 mm and no more than about 20 mm or at least about 3 mm and no more than about 15 mm). In some embodiments, the radius of curvature of the filleted edges 649 is about 1 mm, about 1.1 mm, about 1.2 mm, about 1.3 mm, about 1.4 mm, about 1.5 mm, about 2 mm, about 2.5 mm, about 3 mm, about 4 mm, about 5 mm, about 10 mm, about 15 mm, or about 20 mm.

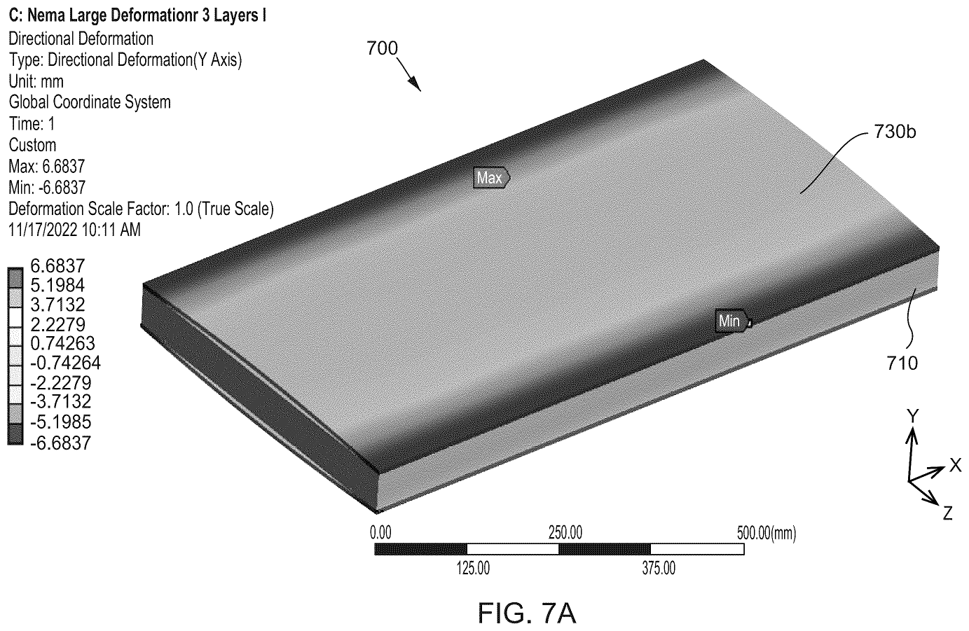

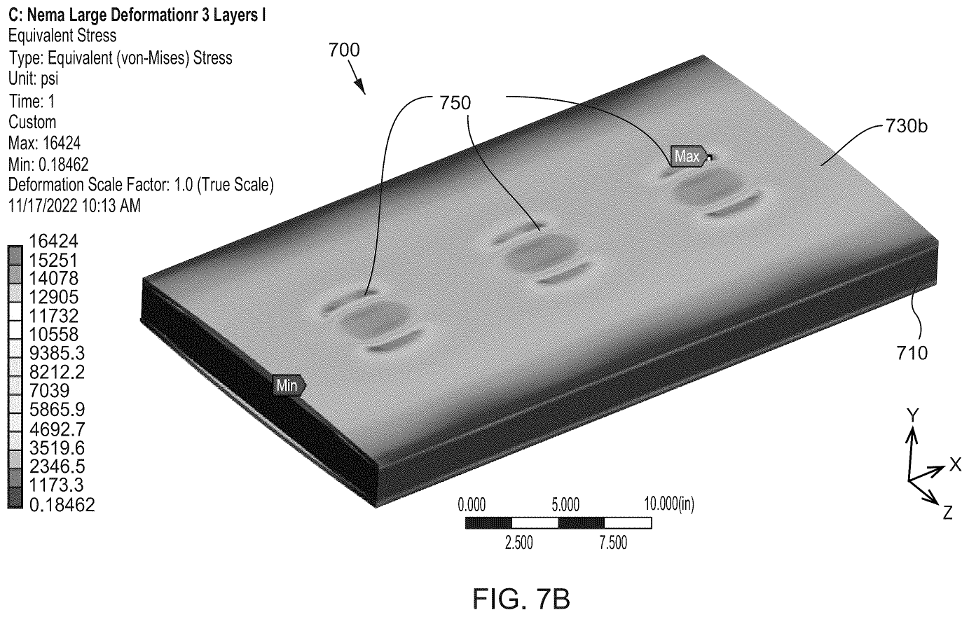

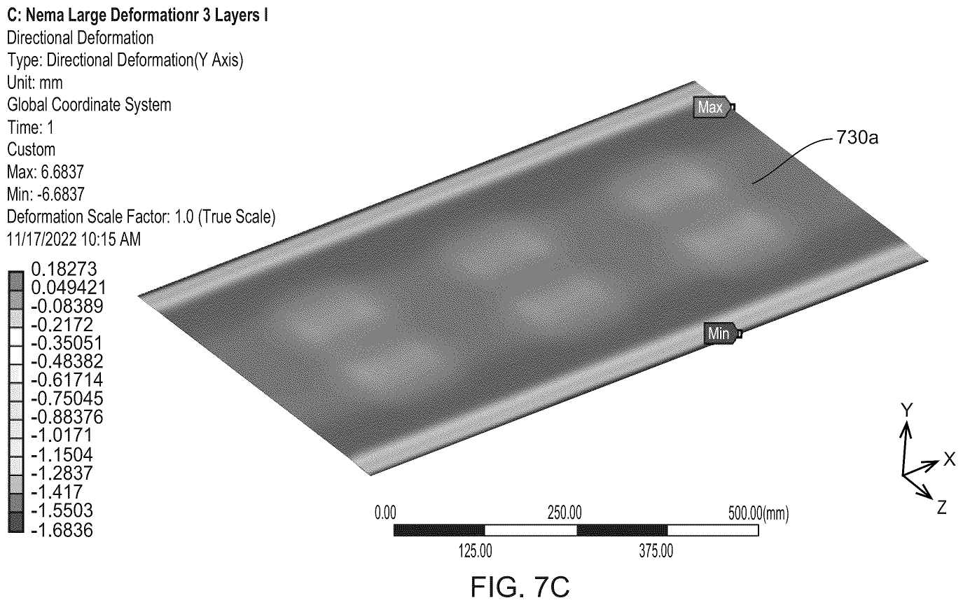

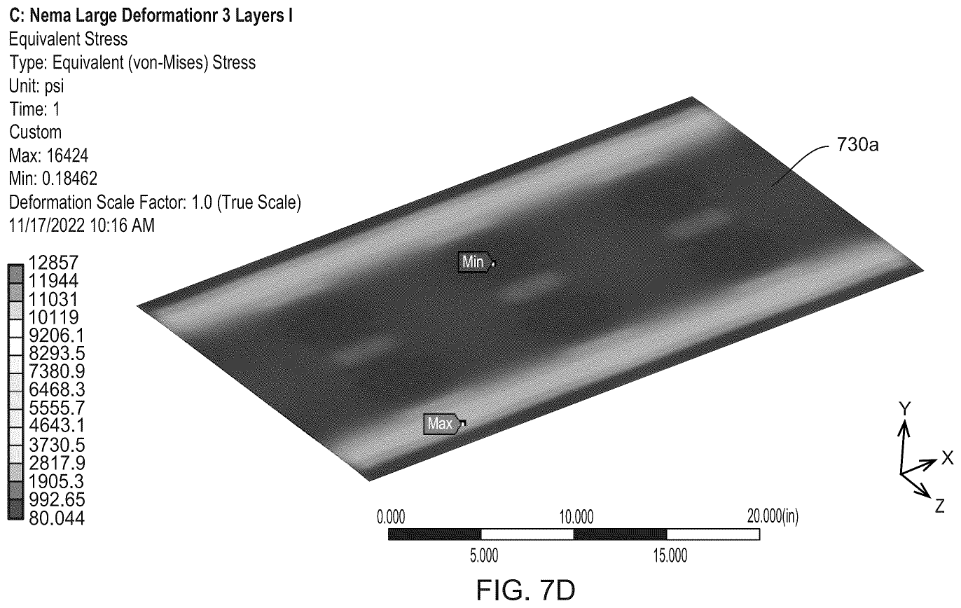

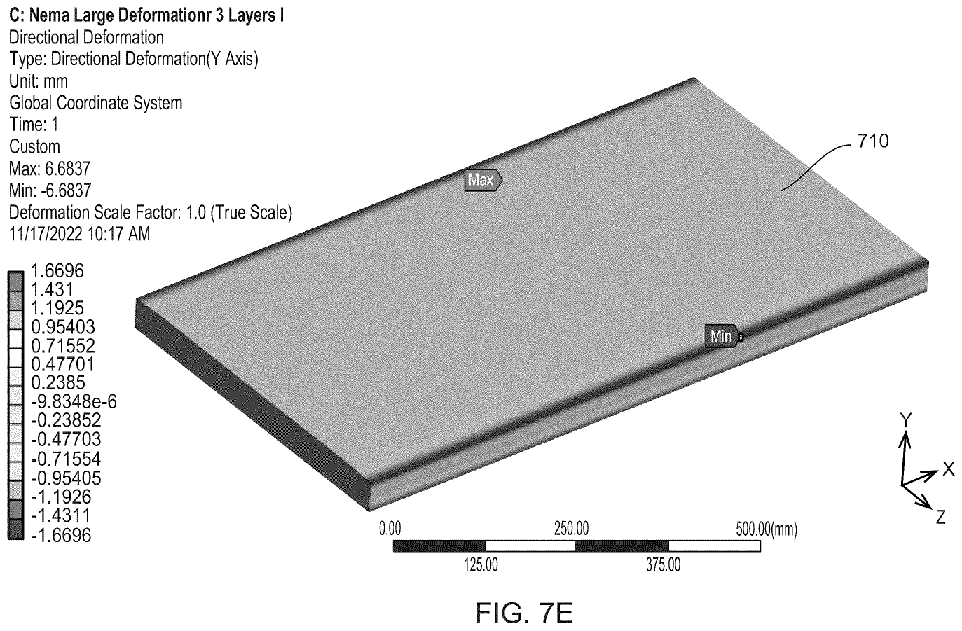

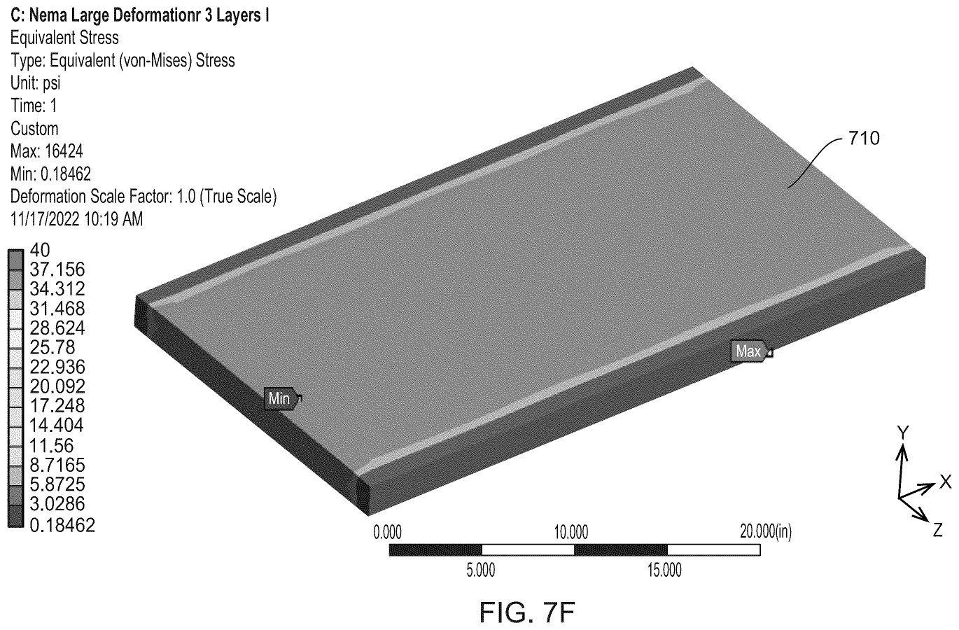

FIGS. 7A-7F are simulation results of an electrochemical cell assembly 700 (e.g., structurally and/or functionally similar to the electrochemical cell assembly 100 of FIG. 1 and/or the electrochemical cell assembly 200 of FIG. 2) in use, according to an embodiment. The electrochemical cell assembly 700 includes a planar sheet 730a (e.g., structurally and/or functionally similar to the planar sheet 130a of FIG. 1), a planar sheet 730b (e.g., structurally and/or functionally similar to the planar sheet 130b of FIG. 1), three ribs stacked between the planar sheet 730a and the planar sheet 730b, an electrochemical cell stack 710 (e.g., structurally and/or functionally similar to the electrochemical cell stack 110 of FIG. 1) below the planar sheet 730b, and a second compression assembly (e.g., functionally and/or structurally similar to the second compression assembly 120b of FIG. 1) below the electrochemical cell stack.

The electrochemical cell assembly 700 is clamped along the length-wise edges or top face with 10,000 pounds force clamping force applied. In FIG. 7A, the resulting deformation of the planar sheet 730b is shown. As seen in FIG. 7A, the planar sheet 730b curves around the ribs such that there is more deformation along the length-wise edges than in the middle of the planar sheet 730b. FIG. 7B shows the von-Mises stress on the planar sheet 730b. The stress on the planar sheet 730b has peaks 750 at the location of the ribs indicating that the planar sheet 730b and the ribs are in contact and the planar sheet 730b exerts force on the ribs.

FIG. 7C depicts the deformation of the planar sheet 730a while the force is applied. As seen in FIG. 7C, the deformation of the planar sheet 730a is substantially uniform across the surface. Similarly, the stress, as seen in FIG. 7D, across most of the planar sheet 730a is substantially uniform. Thus, the planar sheet 730a imparts a substantially uniform pressure across a surface of the electrochemical cell stack 710. As seen in FIG. 7E, the deformation of the electrochemical cell stack 710 across most of the surface is substantially uniform and near zero. Similarly, FIG. 7F shows that the von-Mises stress across most of the surface of the electrochemical cell stack 710. FIGS. 7C-7F show that the ribs allow for the clamping force to be distributed evenly across the electrochemical cell stack 710 and may reduce or prevent swelling during operation.

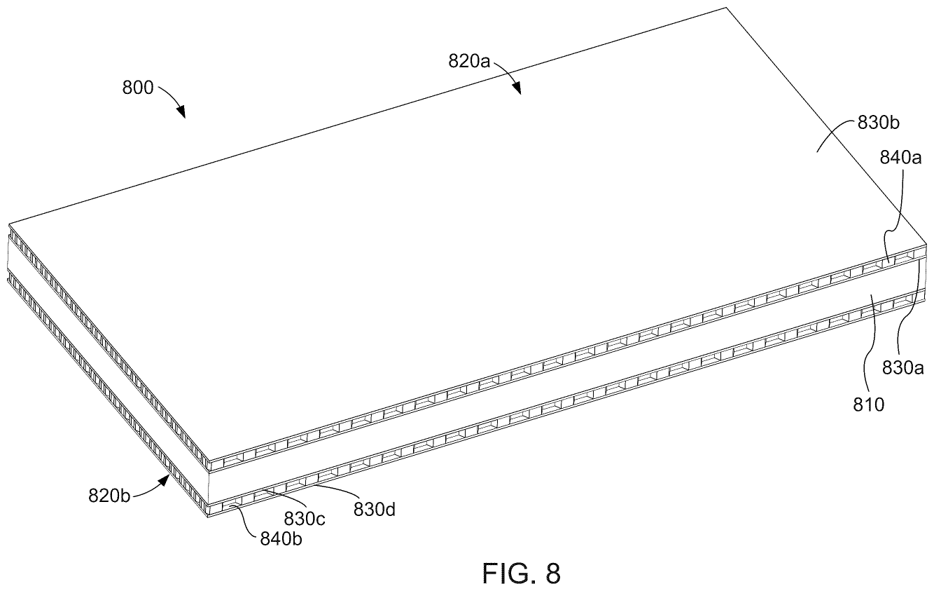

FIG. 8 is an illustration of another electrochemical cell assembly 800 (e.g., functionally and/or structurally similar to the electrochemical cell assembly 100 of FIG. 1), according to an embodiment. The electrochemical assembly 800 includes an electrochemical cell stack 810 (e.g., structurally and/or functionally similar to the electrochemical cell stack 110 of FIG. 1) stacked between a first compression assembly 820a (e.g., structurally and/or functionally similar to the first compression assembly 110a of FIG. 1) and a second compression assembly 820b (e.g., structurally and/or functionally similar to the second compression assembly 110b of FIG. 1).

The first compression assembly 820a includes a porous mesh including a honeycomb structure 840a (e.g., structurally and/or functionally similar to the structural member(s) 140 of FIG. 1) stacked between a planar sheet 830a and a planar sheet 830b (e.g., structurally and/or functionally similar to the planar sheets 130 of FIG. 1). The second compression assembly 820b may also include a porous mesh having honeycomb structure 840b (e.g., structurally and/or functionally similar to the structural member(s) 140 of FIG. 1) stacked between a planar sheet 830c and a planar sheet 830d (e.g., structurally and/or functionally similar to the planar sheets 130 of FIG. 1).

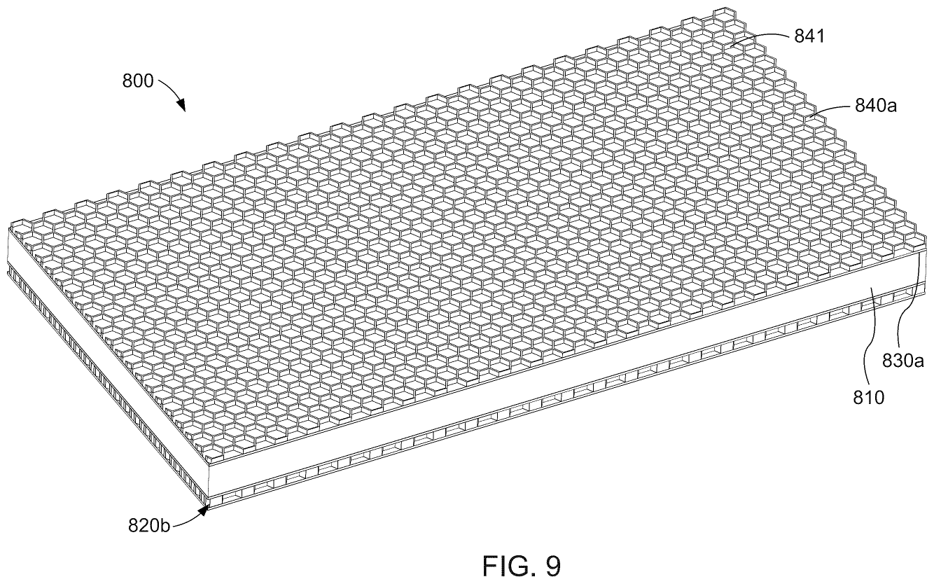

FIG. 9 is an illustration of the electrochemical cell assembly 800 of FIG. 8 with the honeycomb structure 840a exposed by removing the planar sheet 830b. The honeycomb structure 840a is composed of a plurality of cells 841 arranged in a repeating pattern. Each of the plurality of cells 841 are hexagonal in shape. While shown as including hexagonal cells, in some embodiments, the mesh may include cells having any other suitable shape, for example, triangular, square, rectangular, octagonal, or any other suitable polygonal, circular, oval, or asymmetric shape. In some embodiments, the cells 841 can have at least three sides, at least four sides, at least five sides, at least six sides, at least seven sides, at least eight sides, at least nine sides, at least 10 sides, at least 15 sides, or at least 20 sides. In some embodiments, the cells 841 have no more than 20 sides, no more than 15 sides, no more than 10 sides, no more than nine sides, no more than eight sides, no more than seven sides, no more than six sides, no more than five sides, no more than four sides, or no more than three sides. Combinations of the above-referenced number of sides are also possible (e.g., at least three sides and no more than 20 sides or at least about six sides and no more than 10 sides), inclusive of all ranges and values therebetween. In some embodiments, the cells 841 have three sides, four sides, five sides, six sides, seven sides, eight sides, nine sides, 10 sides, 15 sides, 20 sides, or are circular. In some embodiments, the cells 841 of the honeycomb structure 840a can be of various shapes and sizes. In some embodiments, the cells 841 are uniform.

In some embodiments, the height of the honeycomb structure 840a is at least about 0.5 mm, at least about 0.6 mm, at least about 0.7 mm, at least about 0.8 mm, at least about 0.9 mm, at least about 1 mm, at least about 1.5 mm, at least about 2 mm, at least about 2.5 mm, at least about 3 mm, at least about 4 mm, at least about 5 mm, at least about 6 mm, at least about 7 mm, at least about 8 mm, at least about 9 mm, at least about 10 mm, at least about 15 mm, or at least about 20 mm. In some embodiments, the height of the honeycomb structure 840a is no more than about 20 mm, no more than about 15 mm, no more than about 10 mm, no more than about 9 mm, no more than about 8 mm, no more than about 7 mm, no more than about 6 mm, no more than about 5 mm, no more than about 4 mm, no more than about 3 mm, no more than about 2.5 mm, no more than about 2 mm, no more than about 1.5 mm, no more than about 1 mm, no more than about 0.9 mm, no more than about 0.8 mm, no more than about 0.7 mm, no more than about 0.6 mm, or no more than about 0.5 mm. Combinations of the above-referenced heights are also possible (e.g., at least about 0.5 mm and no more than 20 mm or at least about 5 mm and no more than 15 mm), inclusive of all ranges and values therebetween. In some embodiments, the height of the honeycomb structure 840a is about 0.5 mm, about 0.6 mm, about 0.7 mm, about 0.8 mm, about 0.9 mm, about 1 mm, about 1.5 mm, about 2 mm, about 2.5 mm, about 3 mm, about 4 mm, about 5 mm, about 6 mm, about 7 mm, about 8 mm, about 9 mm, about 10 mm, about 15 mm, or about 20 mm.

In some embodiments, the thickness of the walls of the cells 841 is at least about 0.1 mm, at least about 0.2 mm, at least about 0.3 mm, at least about 0.4 mm, at least about 0.5 mm, at least 0.6 mm, at least 0.7 mm, at least about 0.8 mm, at least about 0.9 mm, at least about 1 mm, at least about 1.5 mm, at least about 2 mm, at least about 2.5 mm, at least about 3 mm, at least about 4 mm, or at least about 5 mm. In some embodiments, the thickness of the walls of the cells 841 is no more than about 5 mm, no more than about 4 mm, no more than about 3 mm, no more than about 2.5 mm, no more than about 2 mm, no more than about 1.5 mm, no more than about 1 mm, no more than about 0.9 mm, no more than about 0.8 mm, no more than about 0.7 mm, no more than about 0.6 mm, no more than about 0.5 mm, no more than about 0.4 mm, no more than about 0.3 mm, no more than about 0.2 mm, or no more than about 0.1 mm. Combinations of the above-referenced thicknesses are also possible (e.g., at least about 0.1 mm and no more than 5 mm or at least about 1 mm and no more than 3 mm), inclusive of all ranges and values therebetween. In some embodiments, the thickness of the walls of the cells 841 is about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 1.5 mm, about 2 mm, about 2.5 mm, about 3 mm, about 4 m, or about 5 mm.

In some embodiments, the ratio between the thickness of the walls of the cells 841 and the height of cells 841 is at least about 1:1, at least about 1:1.1, at least about 1:1.2, at least about 1:1.3, at least about 1:1.4, at least about 1:1.5, at least about 1:2, at least about 1:3, at least about 1:4, at least about 1:5, at least about 1:6, at least about 1:7, at least about 1:8, at least about 1:9, at least about 1:10, at least about 1:15, or at least about 1:20. In some embodiments, the thickness of the walls of the cells 841 and the height of the cells 841 is no more than about 1:20, no more than about 1:15, no more than about 1:10, no more than about 1:9, no more than about 1:8, no more than about 1:7, no more than about 1:6, no more than about 1:5, no more than about 1:4, no more than about 1:3, no more than about 1:2, no more than about 1:1.5, no more than about 1:1.4, no more than about 1:1.3, no more than about 1:1.2, no more than about 1:1.1, or no more than about 1:1. Combinations of the above-referenced ratios are also possible (e.g., at least about 1:1 and no more than about 1:20 or at least about 1:1 and no more than 1:10), inclusive of all ranges and values therebetween. In some embodiments, the ratio between the thickness of the walls of the cells 841 and the height of the cells 841 is about 1:1, about 1:1.1, at least about 1:1.2, about 1:1.3, about 1:1.4, about 1:1.5, about 1:2, about 1:3, about 1:4, about 1:5, about 1:6, about 1:7, about 1:8, about 1:9, about 1:10, about 1:15, or about 1:20.

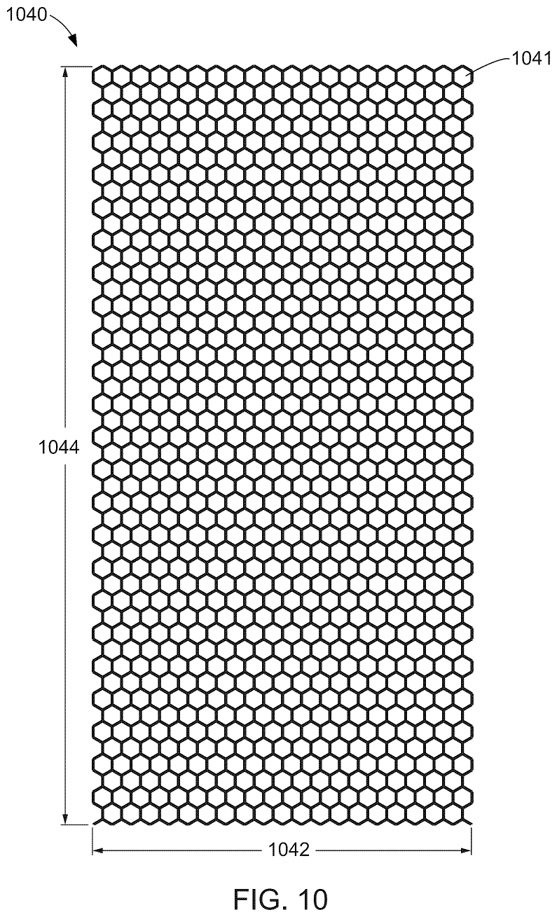

FIG. 10 is a top view of a mesh including a honeycomb structure 1040 (e.g., functionally and/or structurally similar to the honeycomb structure 840 of FIG. 8), according to an embodiment. The honeycomb structure 1040 is formed of cells 1041 (e.g., structurally and/or functionally similar to the cells 841 of FIG. 9) that form a structure that defines a width 1042 and a length 1044. In some embodiments, the honeycomb structure 1040 is the same size and shape as each planar sheet, such as the planar sheets 830 of FIG. 8. In some embodiments, the number of cells 1041 along the width 1042 is at least five, at least six, at least seven, at least eight, at least nine, at least 10, at least 15, at least 20, at last 25, at least 50, or at least 100. In some embodiments, the number of cells 1041 along the width 1042 is no more than 100, no more than 50, no more than 25, no more than 20, no more than 15, no more than 10, no more than nine, no more than eight, no more than seven, no more than six, or no more than five. Combinations of the above-referenced number of cells 1041 are also possible (e.g., at least five and no more than 100 or at least about 10 and no more than 50), inclusive of all ranges and values therebetween. In some embodiments, the number of cells 1041 along the width 1042 is five, six, seven, eight, nine, 10, 15, 20, 25, 50, or 100.

In some embodiments, the number of cells 1041 along the length 1044 is at least 10, at least 15, at least 20, at last 25, at least 50, at least 100, at least 200, at least 300, at least 400, at least 500, at least 1000. In some embodiments, the number of cells 1041 along the length 1044 is no more than 1000, no more than 500, no more than 400, no more than 300, no more than 200, no more than 100, no more than 50, no more than 25, no more than 20, no more than 15, or no more than 10. Combinations of the above-referenced number of cells 1041 are also possible (e.g., at least 10 and no more than 1000 or at least about 100 and no more than 600), inclusive of all ranges and values therebetween. In some embodiments, the number of cells 1041 along the width 1042 is 10, 15, 20, 25, 50, 100, 200, 300, 400, 500, or 1000.

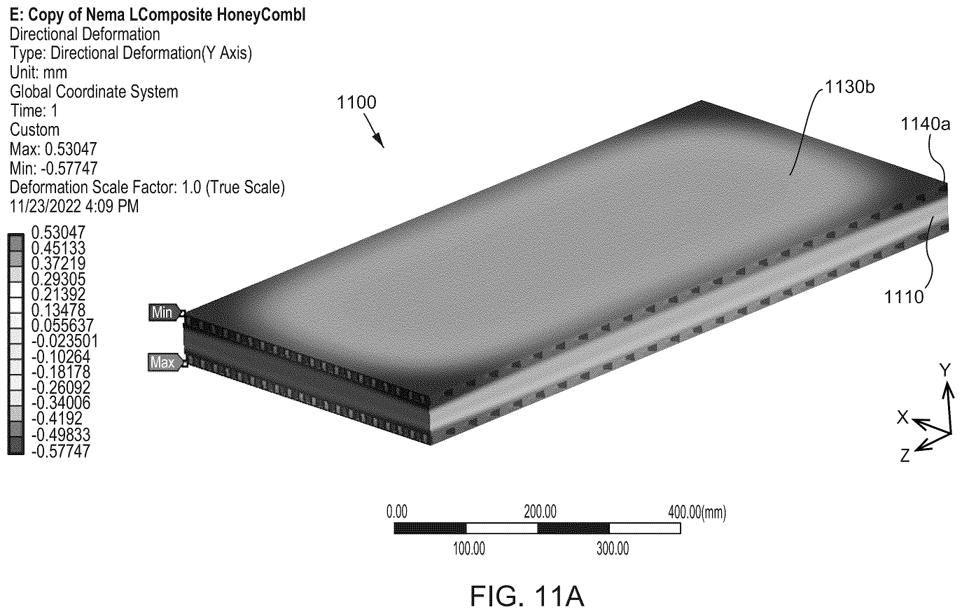

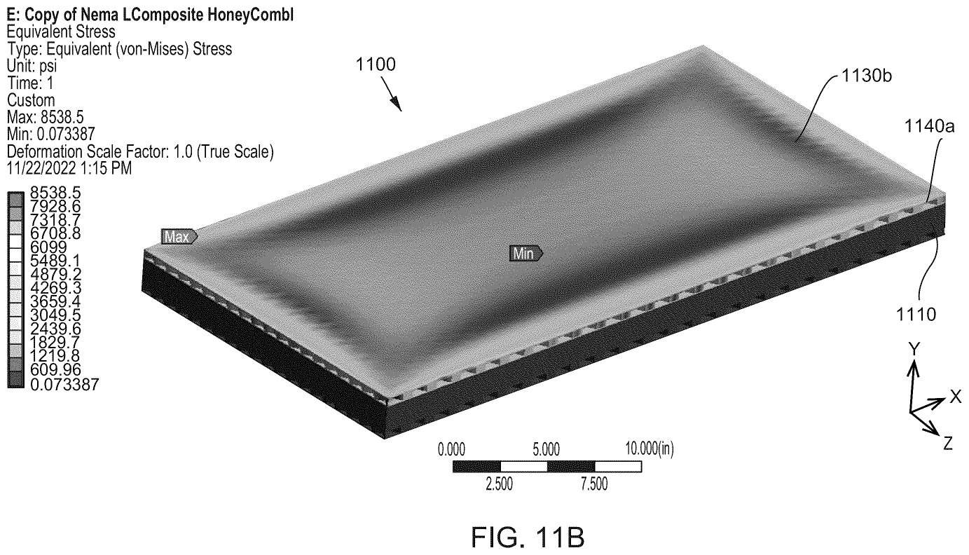

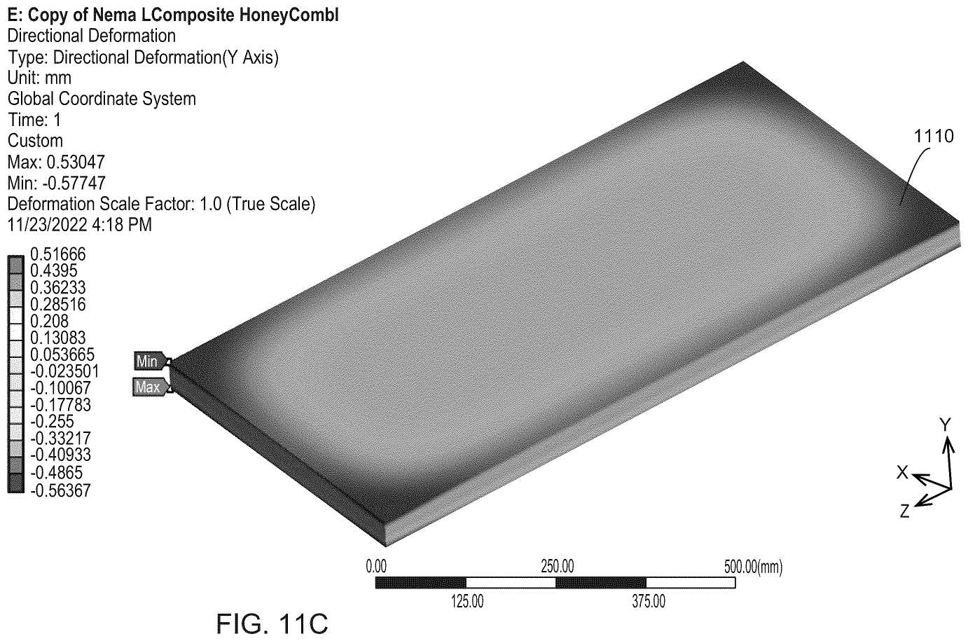

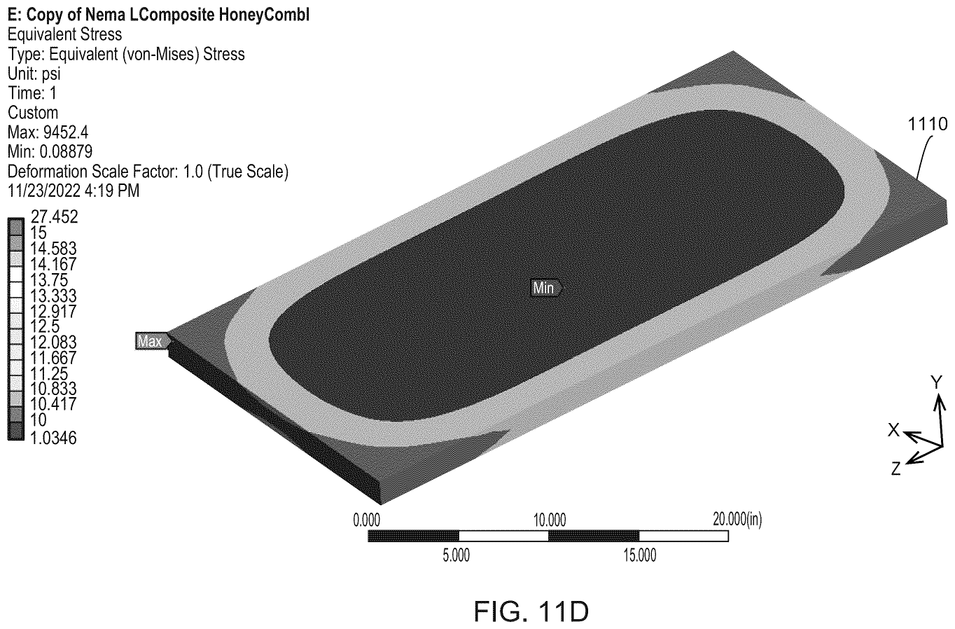

FIGS. 11A-11D are simulation results of an electrochemical cell assembly 1100 (e.g., structurally and/or functionally similar to the electrochemical cell assembly 100 of FIG. 1 and/or the electrochemical cell assembly 800 of FIG. 8) in use, according to an embodiment. The electrochemical cell assembly 1100 includes a lower planar sheet (e.g., structurally and/or functionally similar to the planar sheet 130a of FIG. 1), a planar sheet 1130b (e.g., structurally and/or functionally similar to the planar sheet 130b of FIG. 1), a honeycomb structure 1110 (e.g., structurally and/or functionally similar to the structural member(s) 140 of FIG. 1 and/or the honeycomb structure 840 of FIG. 8), an electrochemical cell stack 1110 (e.g., structurally and/or functionally similar to the electrochemical cell stack 110 of FIG. 1) below the planar sheet 1130b, and a second compression assembly (e.g., functionally and/or structurally similar to the second compression assembly 120b of FIG. 1) below the electrochemical cell stack.

The electrochemical cell assembly 1100 is clamped along the edges or/and the top face with 10,000 pounds force clamping force applied. In FIG. 11A, the resulting deformation of the planar sheet 1130b is shown. As seen in FIG. 11, the planar sheet 1130b has deformation that decreases toward the center area of the planar sheet 1130b. FIG. 11B shows the von-Mises stress on the planar sheet 1130b, which are lower and substantially uniform across the surface of the planar sheet 1130b than at the edges. The planar sheet 1330b contacts the honeycomb structure 1140a and presses down into the lower planar sheet which then, in turn, pressed down into the electrochemical cell stack 1110.

FIG. 11C shows the deformation of the electrochemical cell stack 1110. As seen in FIG. 11C, the deformation of the electrochemical cell stack 1110 is substantially uniform and near-zero in some portions. Similarly, FIG. 11D shows that the von-Mises stress across the surface of the electrochemical cell stack 1110 is substantially uniform. FIGS. 11C-11D show that the honeycomb structure 1140 allows for the clamping force to be distributed substantially uniformly across the electrochemical cell stack 1110 and may reduce or prevent swelling during operation.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrochemical cell assembly, comprising:
a plurality of electrochemical cells arranged in a stack;
a compression assembly, comprising:
a first planar sheet in contact with a first side of the stack;
at least one structural member disposed on a first side of the first planar sheet; and
a second planar sheet disposed on the at least one structural member, the second planar sheet configured to exert a compressive force on the at least one structural member such that the at least one structural member causes the first planar sheet to exert a substantially uniform distributed pressure on the stack.

2. The electrochemical cell assembly of claim 1, wherein the at least one structural member includes a set of structural members disposed at predetermined locations on the first planar sheet.

3. The electrochemical cell assembly of claim 2, wherein each of the set of structural members has a first height at a peripheral edge of the structural member, and a second height at a central location of the structural member, the second height being greater than the first height.

4. The electrochemical cell assembly of claim 3, wherein a first side of each of the structural members facing the first planar sheet is flat, and a second side of structural member facing the second planar sheet is curved.

5. The electrochemical cell assembly of claim 3, wherein a ratio of the second height to the first height is in a range of about 1.2:1 to about 3:1.

6. The electrochemical cell assembly of claim 2, wherein each of the structural member has a rectangular shape such that a ratio of a length to a width of each of the structural member is in a range of about 1:1 to about 10:1.

7. The electrochemical cell assembly of claim 6, wherein a ratio of a length of each of the structural member in a first axial direction to a corresponding width of the stack in the first axial direction is in range of about 1:1.2 to about 1:3.

8. The electrochemical cell assembly of claim 1, wherein the at least one structural member includes a porous mesh defining a plurality of cells.

9. The electrochemical cell assembly of claim 8, wherein the mesh is substantially co-extensive with at least the first planar sheet.

10. The electrochemical cell assembly of claim 8, wherein each of the plurality of cells has a hexagonal shape such that the mesh has a honeycomb structure.

11. The electrochemical cell assembly of claim 8, wherein a ratio of a thickness of a wall of each of the plurality of cells to a height of the mesh is in a range of about 1:1 to about 1:10

12. The electrochemical cell assembly of claim 1, wherein the compression assembly is a first compression assembly, the at least one structural member is a first structural member, and the electrochemical cell assembly further comprises a second compression assembly including:
a first planar sheet in contact with a second side of the stack opposite the first side of the stack;
at least one second structural member disposed on a first side of the first planar sheet; and
a second planar sheet disposed on the at least one second structural member, the second planar sheet configured to exert a compressive force on the at least one second structural member such that the at least one second structural member causes the first planar sheet to exert a substantially uniform distributed pressure on the second side of the stack.

13. The electrochemical cell assembly of claim 12, further comprising a clamp configured to impart a compressive force on the first compression assembly and the second compression assembly.

14. An assembly, comprising:
a first planar layer configured to be disposed on a surface of an electrochemical cell stack such that a first surface of the first planar layer contacts the surface of the electrochemical cell stack;
a structural member disposed on a second surface of the first planar layer opposite the first surface of the first planar layer; and
a second planar layer disposed on the structural member opposite the second surface of the first planar layer,
the second planar layer configured to exert a compressive force on the structural member in response to a force being exerted on the second planar layer such that the structural member causes the first planar layer to exert a substantially uniform distributed pressure on the electrochemical cell stack when the assembly is disposed on the electrochemical cell stack.

15. The assembly of claim 14, wherein the structural member has a length and a width that is less than a corresponding length and width of the first planar layer and the second planar layer.

16. The assembly of claim 14, wherein the structural member includes a set of structural members disposed at predetermined locations on the first planar layer.

17. The assembly of claim 16, wherein each of the set of structural members has a first height at a peripheral edge of the structural member, and a second height at a central location of the structural member, the second height being greater than the first height.

18. The assembly of claim 16, wherein a first side of each of the set of structural members facing the first planar sheet is flat, and a second side of structural member facing the second planar sheet is curved.

19. The assembly of claim 14, wherein the at least one structural member includes a porous mesh defining a plurality of cells.

20. The assembly of claim 19, wherein the mesh is substantially co-extensive with at least the first planar sheet.

21. The assembly of claim 19, wherein each of the plurality of cells has a hexagonal shape such that the mesh has a honeycomb structure.

22. The assembly of claim 19, wherein a ratio of a thickness of a wall of each of the plurality of cells to a height of the mesh is in a range of about 1:1 to about 1:10

23. The assembly of claim 14, further comprising a clamp configured to impart a compressive force on the compression assembly.

24. An electrochemical cell assembly, comprising:
a plurality of electrochemical cells arranged in a stack;
a compression assembly, comprising:
a planar sheet in contact with a first side of the stack; and
at least one structural member disposed on a first side of the first planar sheet,
wherein in response to a compressive force being exerted on the at least one structural member in a direction towards the planar sheet, the at least one structural member causes the planar sheet to exert a substantially uniform distributed pressure on the stack.

25. The electrochemical cell assembly of claim 24, wherein:
the planar sheet is a first planar sheet, and
the electrochemical cell assembly further comprises a second planar sheet disposed on the at least one structural member opposite the first planar sheet, the second planar sheet configured to exert the compressive force on the first planar sheet.

26. The electrochemical cell assembly of claim 24, further comprising:
a housing defining an internal volume within which the stack and the compression assembly is disposed,
wherein a sidewall of the housing is configured to contact the at least one structural member and exert the compressive force on the at least one structural member.

27. The electrochemical cell assembly of claim 24, wherein the at least one structural member includes a set of structural members disposed at predetermined locations on the planar sheet.

28. The electrochemical cell assembly of claim 27, wherein each of the set of structural members has a first height at a peripheral edge of the structural member, and a second height at a central location of the structural member, the second height being greater than the first height.

29. The electrochemical cell assembly of claim 28, wherein a first side of each of the structural members facing the planar sheet is flat, and a second side of structural member opposite the first side is curved.

30. The electrochemical cell assembly of claim 24, wherein the at least one structural member includes a porous mesh defining a plurality of cells.

31. The electrochemical cell assembly of claim 30, wherein the mesh is substantially co-extensive with the planar sheet.

32. The electrochemical cell assembly of claim 30, wherein each of the plurality of cells has a hexagonal shape such that the mesh has a honeycomb structure.
